(19) United States
(12) Patent Application Publication
(10) Pub. No.: US 2009/0260790 A1
(43) Pub. Date: Oct. 22, 2009

(54) METAL TUBES FOR HEAT PIPES AND METHOD OF MANUFACTURING THE SAME

(76) Inventors: Cheng-Tu WANG, Taipei (TW); Pang-Hung LIAO, Taipei (TW); Kuo-Feng TSENG, Taipei (TW)

Correspondence Address: HDLS Patent & Trademark Services, P.O. BOX 220746, CHANTILLY, VA, 20153-0746, US

(21) Appl. No.: 12/106,411

(22) Filed: Apr. 21, 2008

(51) Int. Cl. F28F 1/00; B23P 15/26

(52) U.S. Cl. 165/177; 29/890.053

(57) ABSTRACT

In metal tubes for heat pipes and a method of manufacturing the metal tubes, a metal tube includes a tube defining an inner space, and at least one dividing portion extruding from an inner sidewall of the metal tube. The at least one dividing portion divides the inner space into a vapor channel and a liquid channel connected to the vapor channel. The metal tubes can prevent heat pipe form being dried out and improve heat dissipation efficiency of heat pipes.

### BACKGROUND

The present invention generally relates to heat pipes, and more especially, relates to metal tubes for heat pips and method of manufacturing the metal tubes.

With continuous progress of operation rate of central process unit (CPU), more and more heat is produced when the CPU is in use. Conventional heat dissipation apparatus comprised of aluminum extrusion type heat sink and fan can't sufficiently dissipate heat generated by CPU; therefore, heat pipe is developed to meet the increased heat dissipation requirement. Generally, heat pipe is used accompany with heat sink. Inner structure design and amount of working fluid disposed in heat pipe are very important parameters that affect heat dissipation ability of heat pipe. When there is too much working fluid filled in the heat pipe the vapor channel in the heat pipe will be too small, as a result, heat dissipation efficiency of heat pipe decreases a lot; in contrast, when there is too little working fluid the heat pipe may be dried out, and even damaged. The present inventor provides a new metal tube for heat pipe and method of manufacturing the same.

Conventional metal tubes used in heat pipes are usually made of seamless copper tube, for example, as disclosed in published Taiwan Patent Publication Nos. 200720614, 200720615 and 200720616. Capillaries are employed in these heat pipes as dividing grooves thereby structuring a number of vapor channels and liquid channels in the heat pipe.

However, in these heat pipes, although the liquid channels and the vapor channels are separated from each other, vapor channels are formed at inner edge and outer edge of the liquid channels. As a result, when the working fluid in the heat pipes are gasified the produced steam doesn't move along a certain path, thus the steam and cooled working fluid interfere with each other thereby decreasing the heat dissipation efficiency.

In addition, in a method of manufacturing such heat pipes, a dividing plate is wrapped with capillaries at first, and then the dividing plate is inserted into a metal tube, and finally working fluid is injected into the metal tube. Generally, a diameter of a heat pipe is very small; the capillaries wrapping step is very difficult, not to say of disposing the resulted structure in the metal tube and attaching the resulted structure to an inner sidewall of the metal tube. Therefore, there is a desire to develop metal tubes for heat pipes to simplify manufacturing process of heat pipes.

### BRIEF SUMMARY

The present invention provides a metal tube for heat pipe and a method of manufacturing the same. Vapor channel and liquid channel are directly formed in the metal tube, as a result, the heat pipe can be avoided from being dried out; furthermore, a heat dissipation rate and efficiency of the heat pip is greatly improved.

In one exemplary embodiment, a metal tube includes a tube defining an inner space, at least one dividing portion extrudes from an inner sidewall of the metal tube. The at least one dividing portion divides the inner space into a vapor channel and a liquid channel connected to the vapor channel.

In another exemplary embodiment, a method of manufacturing a metal tube for heat pipe includes steps of: a) providing a tube, a number of dividing portions extruding from an inner sidewall of the tube; and b) applying a pressure onto the dividing portions using a tool such that end surfaces thereof are adjoined with each other thereby defining a vapor channel and a liquid channel in an inner space of the tube.

In still another exemplary embodiment, a method of manufacturing a metal tube for heat pipe includes steps of: a) providing a tube, at least one dividing portion extruding from an inner sidewall of the tube; and b′) applying a pressure onto the tube such that an end surface of the dividing portion adjoin an inner sidewall of the tube other thereby defining a vapor channel and a liquid channel in an inner space of the tube.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a flow chart of a method of manufacturing a metal tube of the present invention;

FIG. 2 is a cross sectional view of a metal tube prior to being processed by a shaping tool;

FIG. 3 is a cross sectional view of the metal tube after being processed by a shaping tool;

FIG. 4 is a cross sectional view of the metal tube along another direction;

FIG. 5 is a schematic view of the metal tube of FIG. 3 being employed in a heat pipe;

FIG. 6 is a schematic view illustrating a practical application of the heat pipe in FIG. 5;

FIG. 7 is a flow chart of a method of manufacturing a metal tube in accordance with a second embodiment;

FIG. 8 is a cross sectional view of a metal tube in accordance with another embodiment;

FIG. 9 is a cross sectional view of the metal tube of FIG. 8 after being pressed;

FIG. 10 is a cross sectional view of a metal tube in accordance with still another embodiment; and

FIG. 11 is a cross sectional view of the metal tube of FIG. 10 after being pressed.

### DETAILED DESCRIPTION

The present invention will be described in detail accompany with the drawings as following. However, it is understood that the drawings illustrate the present invention, but not restrict the present invention.

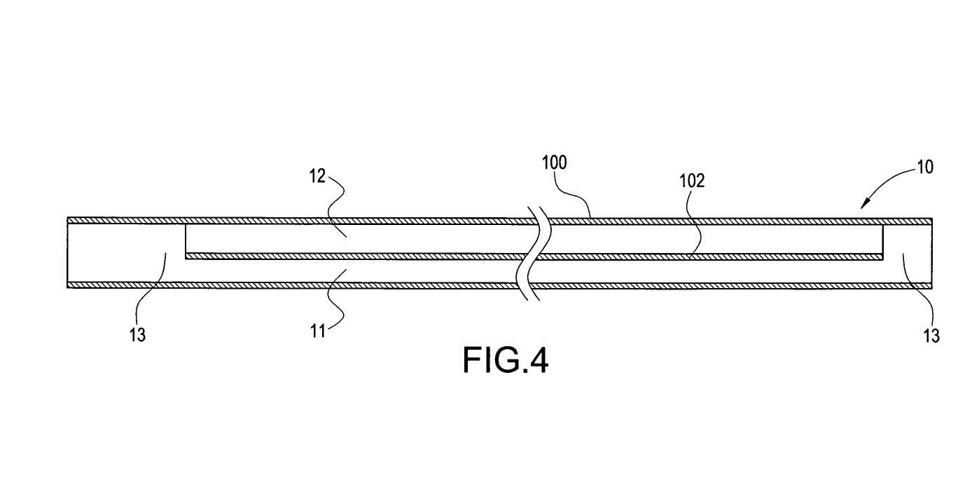

The present invention provides a metal tube used in heat pipes. As shown in FIG. 3, a metal tube 10 includes a tube 100, two dividing portions 101, 102 extruding from an inner sidewall of the tube 100 thereby dividing an inner space of the tube 100 into a vapor channel 11 and a liquid channel 12. In the present embodiment, a length of the liquid channel 12 is less than that of the vapor channel 11, thus, two connecting sections 13 are provided at two ends of the vapor channel 11 (referring to FIG. 4).

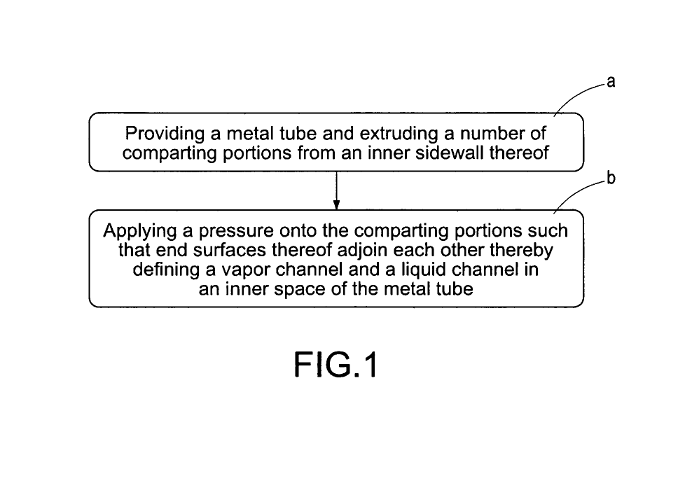

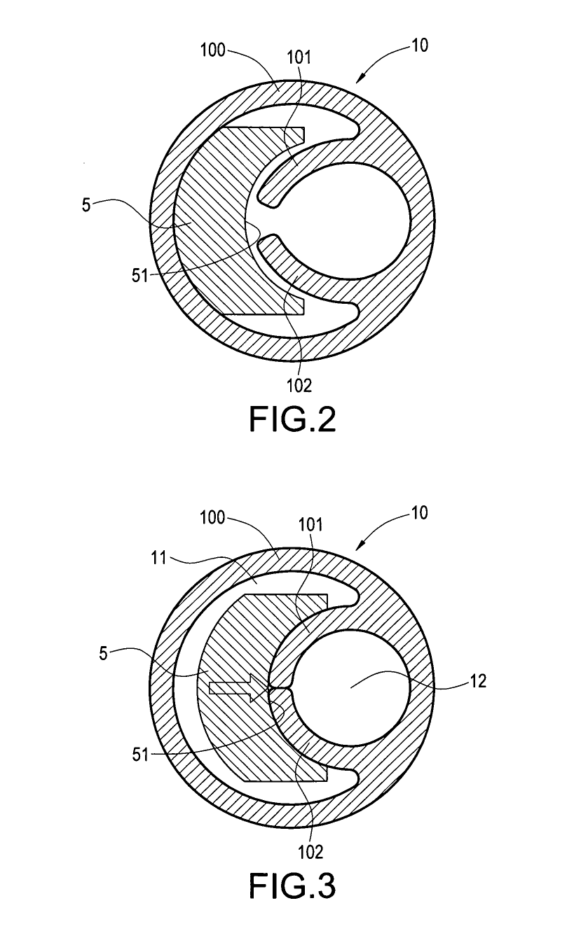

FIG. 1 illustrates a flow chart of manufacturing the metal tube for heat pipes of the present invention in accordance with a first embodiment, and FIGS. 2-4 illustrate cross sectional views of the metal tube in different steps. The method will be described in detail with reference to these figures.

In step a), referring to FIG. 2, a tube 100 is provided, two dividing portions 101, 102 extruding from an inner sidewall of the tube 100. In this step, the tube 100 is made of the material having high heat conductivity and heat dissipation ability such as copper, and the tube 100 can be circular or other shaped. During forming of the tube 100, a special mold is disposed in the tube 100 thereby two arc shaped dividing portions 101, 102 are extruded from the inner sidewall of the tube 100.

In step (b), the two dividing portions 101, 102 are pressed using a tool 5 thereby forming a vapor channel 11 and a liquid channel 12 (as shown in FIGS. 2 and 3). In the present embodiment, the tool 4 has a semi-circular groove 51 for applying a pressure to the two dividing portions 101, 102. When adequate pressure is applied the plastic deformation occurs in the two dividing portions 101, 102 thereby forming the vapor channel 11 and the liquid channel.

In addition, the method of manufacturing the metal tube of the present invention includes step c), in which the dividing portions 101,102 are machined using a tool to form a connecting section 13 (as shown in FIG. 4) at two ends of the tube 100. In this step, the tool can be a lathe tool or a milling cutter. Two ends of the dividing portions 101, 102 are removed thereby forming connecting sections 13 at the two ends respectively. Furthermore, it is understood that the step c) can also be performed prior to the step b).

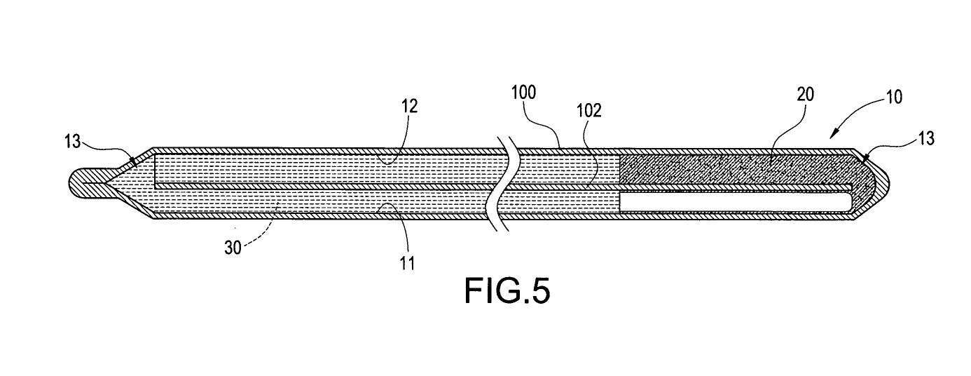

FIG. 5 illustrates a cross sectional view of a heat pipe including the metal tube in the above described embodiment. During a process of making the heat pipe, firstly, an end of the metal tube 10 is sealed by welding, and then a rod is inserted into the vapor channel 11. In sequence, the metal powder is poured into the tube 100 and distributed in lower ends of the vapor channel 11, the liquid channel 12, and the lower connecting section 13. The metal powder in the tube 100 is sintered such that great deals of capillaries 20 are formed in the lower end of the metal tube 10. The working fluid is filled in the tube 10 and air in the tube 10 is removed by heating the tube 10 thereby forming a vacuum chamber in the tube 10. Finally, another end of the tube 10 is sealed by pressing and a heat pipe is thereby obtained.

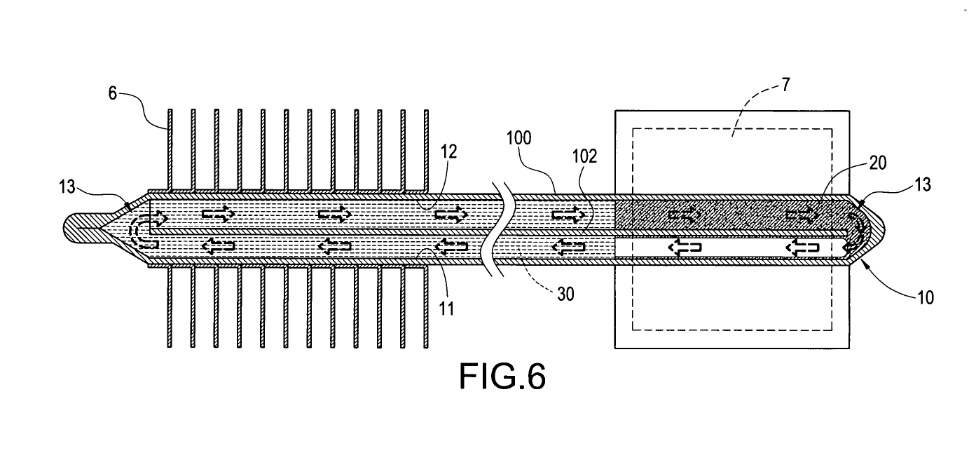

FIG. 6 is a schematic view illustrating a practical application of the heat pipe in FIG. 5. An end of the heat pipe is surrounded by a heat sink 6, and another end of the heat pipe is attached to an electronic device 7. Heat generated by the electronic device 7 gasifies the working fluid 30 thereby producing a mass of working fluid steam. The working fluid steam will move in the vapor channel 11 along a direction toward to the heat sink 6 due to a pressure difference between the two ends of the tube till the working fluid steam entering the connecting section. The heat sink 6 absorbs heat contained in the working fluid steam and dissipates the heat out to the ambient air. Thus, the working fluid steam is cooled back to the working liquid; the cooled working fluid moves in a front end of the liquid channel 12 and reaches to the capillaries 20 under effect of gravity or pressure difference, and then the cooled working fluid moves in the capillaries 20 under capillary force. Finally, the cooled working fluid comes back to the end of the tube attached to the electronic device 7 and a heat dissipation circle is completed. Generally, the working fluid 30 has a very high specific heat capacity; furthermore, the heat dissipation circle is performed efficiently, as a result, the heat generated by the electronic device 7 is quickly removed.

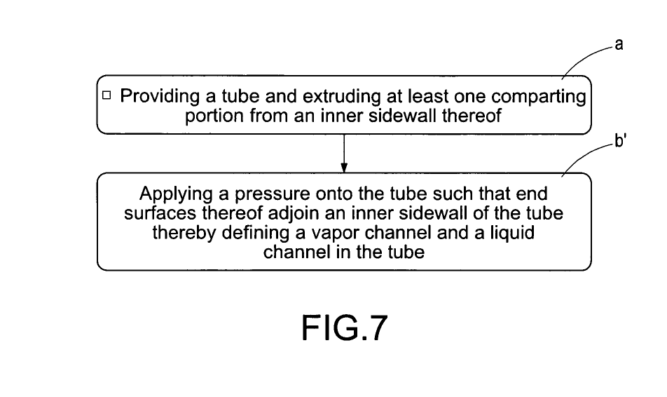

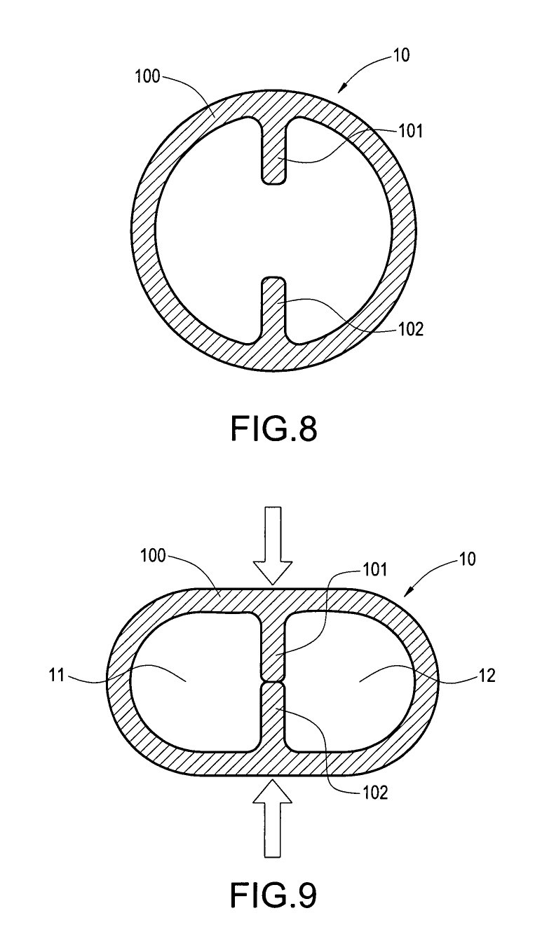

FIG. 7 is a schematic view of a method of manufacturing a heat pipe according to another embodiment. In this embodiment, a step b‘) is used to replace the step b) in the method of above described embodiment. In step b′), referring to FIG. 8, a metal tube 20 is pressed using a pressing tool. The metal tube 20 includes a cylinder tube 200. A first dividing portion 201 and a second dividing portion 202 extrude from an inner sidewall of the tube 200 erectly and extend to each other. The metal tube 20 is pressed such that end surfaces of the first dividing portion 201 and the second dividing portion 202 are adjoined to each other thereby forming a vapor channel 21 and a liquid channel 22 in the tube 200.

In addition, as described in step c) of the method in the first embodiment, the dividing portions 201, 202 can be processed using a tool to form a connecting section at two ends of the tube 200. Furthermore, it is understood that this step can be performed prior to or after the step b′).

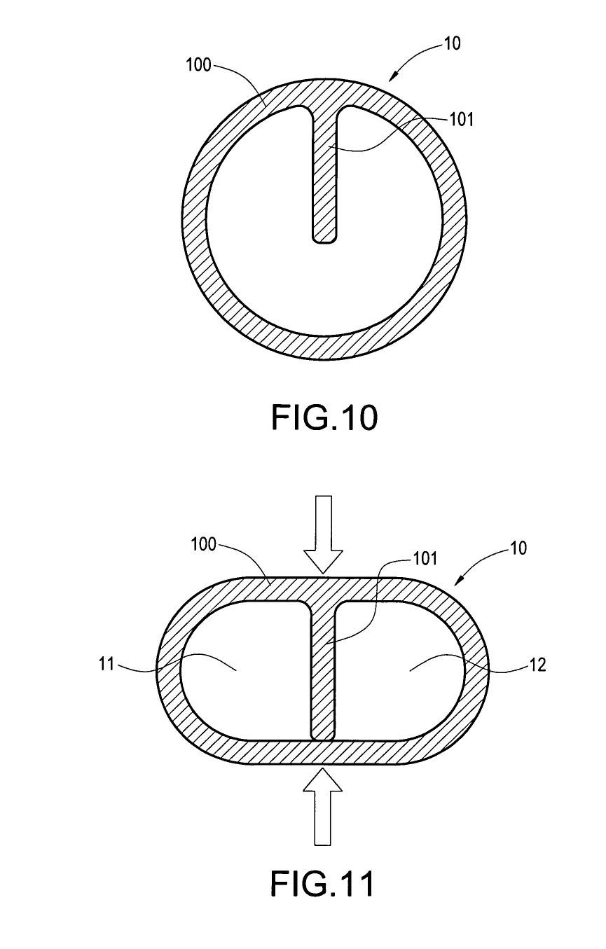

FIG. 10 illustrates a metal tube 30 of the present invention in accordance with a third embodiment. The metal tube 30 includes a tube 300, and a dividing portion 301 extruding from an inner sidewall of the tube 300 erectly. Referring to FIG. 11, an outer surface of the metal tube 30 is pressed such that an end surface of the dividing portion 301 reaches to the inner sidewall of the tube 300 thereby dividing an inner space of the tube 300 into a vapor channel 31 and a liquid channel 32. It is understood that the vapor channel 31 and the liquid channel 32 are connected at two ends of the tube 300 (not shown).

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A metal tube for heat pipes, comprising:
a tube defining an inner space;
at least one dividing portion extruding from an inner sidewall,
wherein the at least one dividing portion divides the inner space into a vapor channel and a liquid channel connected to the vapor channel.

2. The metal tube for heat pipes as claimed in claim 1, wherein the tube is made of copper.

3. The metal tube for heat pipes as claimed in claim 1, wherein the dividing portion extrudes from the inner sidewall erectly, and an end surface of the dividing portion adjoins the inner sidewall.

4. The metal tube for heat pipes as claimed in claim 1, wherein two dividing portions extrude from the inner sidewall, the two dividing portions are arc shaped, and an end surface of each of the two dividing portions adjoins with each other.

5. The metal tube for heat pipes as claimed in claim 1, wherein two dividing portions extrude from the inner sidewall erectly, and an end surface of each of the two dividing portions adjoins with each other.

6. The metal tube for heat pipes as claimed in claim 1, wherein a length of the liquid channel is less than that of the vapor channel, and two connecting sections are provided at two ends of the vapor channel respectively.

7. A method of manufacturing a metal tube for heat pipes, comprising:
a) providing a tube, a number of dividing portions extruding from an inner sidewall of the tube;
b) applying a pressure onto the dividing portions using a tool such that end surfaces thereof are adjoined with each other thereby defining a vapor channel and a liquid channel in an inner space of the tube.

8. The method as claimed in claim 7, wherein the dividing portions are arc shaped.

9. The method as claimed in claim 7, further comprising: c) forming a connecting section in each of two ends of the tube using a cutter.

10. The method as claimed in claim 9, wherein the step c) is performed prior to the step b).

11. The method as claimed in claim 9, wherein the step c) is performed after the step b).

12. A method of manufacturing a metal tube for heat pipes, comprising:
a) providing a tube, at least one dividing portion extruding from an inner sidewall of the tube;
b′) applying a pressure onto the tube such that an end surface of the dividing portion adjoins an inner sidewall of the tube thereby defining a vapor channel and a liquid channel in an inner space of the tube.

13. The method as claimed in claim 12, wherein the dividing portion extrudes from the inner sidewall erectly.

14. The method as claimed in claim 12, further comprising: c) forming a connecting section in two ends of the tube using a cutter.

15. The method as claimed in claim 12, wherein the step c) is performed prior to the step b′).
The method as claimed in claim 12, wherein the step c) is performed after the step b′).
